(19) United States
(12) Patent Application Publication
(10) Pub. No.: US 2026/0262621 A1
(43) Pub. Date: Sep. 10, 2026

(54) FISHING REEL WITH SPOOL ROTATION CONTROL MECHANISM

(71) Applicants: Pure Fishing Japan Co., Ltd, Tokyo (JP); Jia Dun Sports Equipment Co., LTD, Guangzhou (CN)

(72) Inventors: Eigo Urabe, Katsuura (JP); Chi Shing Li, Hong Kong (HK); Guo Hua Zang, Guangzhou (CN); Chao Yong Zhang, Guangxi (CN)

(21) Appl. No.: 18/704,598

(22) PCT Filed: Oct. 3, 2023
(86) PCT No.: PCT/JP2023/035991

§ 371 Date: May 15, 2026

(51) Int. Cl. A01K 89/0155

(52) U.S. Cl. CPC A01K 89/01555

(57) ABSTRACT

A cam mechanism used in a mechanism for preventing backlash is composed of a cam pin and a cam contact end with a specific shape.

### CROSS REFERENCE

This application claims priority to PCT Application No. PCT/JP2023/035991, filed Oct. 3, 2023, the entirety which is hereby incorporated by reference.

### FIELD OF THE INVENTION

The present invention relates to a fishing reel with a spool rotation control mechanism. More specifically, the present invention relates to a fishing reel with a mechanism of controlling rotation of a spool using an electromagnetic brake.

### BACKGROUND OF THE INVENTION

Fishing reels include spinning reels, double-bearing reels, and single-bearing reels. In the spinning reels, a spool is attached to a reel main body in a back-and-forth movable manner, and in the double-bearing reels and the single-bearing reels, a spool is rotatably supported by a reel main body. In the double-bearing reels and the single-bearing reels with such a structure, the spool can directly receive force applied to a line, and these reels are used as a bait reel that casts a heavy lure or rig (hereinafter, it is abbreviated as a lure, etc.).

On the other hand, the double-bearing reels and the single-bearing reels are prone to a so-called backlash, a phenomenon in which a line is entangled in a spool at the time of casting due to the spool directly receiving force applied to the line.

When casting a lure, etc., the lure, etc. flies in a parabolic pattern, and a fishing line connected thereto is pulled out from a spool arbor. At the initial stage immediately after the release of a lure, etc., the rotational speed of a spool is not so high, but thereafter, the rotational speed of the spool increases to follow the flight speed of the lure, etc. After the lure, etc. passes the apex of the parabola, the flight speed of the lure, etc. decreases due to air resistance, etc., whereas the spool tries to continue to rotate without reducing the rotation speed much due to the law of inertia. When the lure, etc. lands on the water, force of pulling the fishing line by the lure, etc. becomes zero, but even in this state, the spool continues to rotate although the rotation speed decreases.

As a result, the amount of the fishing line supplied from the spool arbor becomes greater than the amount of the fishing line pulled by the lure, etc., causing a so-called backlash.

Ordinarily, a method of preventing such backlash is to generate friction braking force by pressing a spool with a thumb at the time of casting (so-called thumbing). However, this thumbing operation can be appropriately performed only by experienced anglers, so there is a demand for a reel that can prevent backlash even by an angler who is not accustomed to using bait reels.

In response to such a demand, bait reels with various mechanisms for preventing backlash has been developed, one of which is a bait reel that generates braking force against rotation of a spool by magnetic force between magnetic and dielectric materials, and adjusts the braking force according to the rotation speed of the spool, thereby preventing backlash while suppressing decrease in a flying distance of the lure, etc. (for example, Patent Literatures 1 and 2).

### SUMMARY OF THE INVENTION

However, the conventional bait reels with such a backlash-preventing mechanism have been required to be improved in several points.

First, in the reels, a cam mechanism for adjusting the distance between magnetic and dielectric materials according to the rotation speed of a spool was structured as illustrated in FIG. 1(a) and 1(b), where a cam pin 32 engages with a cam groove 31 closed from the outside by partition walls. Therefore, when the cam pin 32 moves, it receives frictional resistance from the two partition walls, which requires a relatively large force for the cam pin 32 to move, and delays the cam pin 32 returning to the initial position after casting.

In a cam mechanism with such a cam groove 31, foreign matter such as sand can easily enter the cam groove 31 and remains when a reel is used outdoors, and it may not be completely removed even when the reel is washed with water. Thus, remaining foreign matter such as sand may cause the reel to malfunction or even break down in some cases.

In addition, in order to form a cam groove 31, a metal material is present in the periphery of the groove, which hinders weight reduction of a moving member that is responsible for a cam mechanism, causing a relatively large force to be required for the cam pin 32 to move, and also becoming a cause of hindering weight reduction of the reel.

In the reel as disclosed in Japanese reference JP-B-3464362, the cam groove 31 is asymmetric with respect to a spool shaft, and it was necessary to produce different cam mechanisms dependent on whether reels have a handle assembly on the right side or the left side of their reel main bodies.

An object of the present invention is to solve the problems of the conventional bait reel with such a backlash-preventing mechanism.

As a means for solving the above problem, the present invention provides, in one embodiment thereof, a bait reel comprising: a spool comprising a spool shaft, optionally a sleeve fixed to the spool shaft to cover at least a portion of the spool shaft, and a spool arbor connected to the spool shaft or the sleeve, a reel frame that rotatably holds the spool, and a rotation control mechanism capable of controlling rotation of the spool, wherein the rotation control mechanism comprises an electromagnetic brake structure that generates braking force against rotation of the spool, and a braking force adjustment mechanism that controls the braking force; the electromagnetic brake structure comprises paired magnetic and conductive members, and one of the magnetic and conductive members is disposed to the braking force adjustment mechanism and the other to the reel frame in such a manner they are capable of becoming close to each other by the braking force adjustment mechanism; the braking force adjustment mechanism comprises: a cam pin that is provided on the spool shaft or the sleeve and protrudes in a direction substantially perpendicular to an axial direction of the spool shaft, a moving member in a cylindrical form with a circular cross section that is rotatable coaxially with the spool shaft and is movable in the axial direction of the spool shaft within a certain range, wherein the moving member has a cam contact end with which the cam pin is engageable; and an urging member that presses the moving member in a spool axial direction from one end side; the magnetic or conductive member is connected to or near an end of the moving member on the side opposite to the cam contact end, and the cam contact end has a shape defined by a line inclined with respect to an axial center of the spool shaft and toward the side opposite to the magnetic or conductive member, preferably a shape defined by a line having a apex at a position corresponding to an axial center of the spool shaft, and sloping away from the apex in vertical directions with respect to the axial center of the spool shaft toward the side opposite to the magnetic or conductive member, and with line-symmetry with respect to the spool shaft, the urging member presses the moving member from the side of the magnetic or conductive member to allow the cam pin to engage with the cam contact end, and the moving member, to which the magnetic or conductive member is fixed, to move in the axial direction of the spool shaft according to a difference between rotational speed of the spool and rotational speed of the moving member, thereby controlling a distance between the paired magnetic and conductive members.

In a preferred embodiment, a stop position defining member is fixed to the spool shaft or the sleeve in such a manner as to be disposed adjacent to the urging member directly or via another member and on the side opposite to the moving member side of the urging member, thereby positioning the urging member and maintaining urging force. The stop position defining member is preferably in a doughnut-shape with a predetermined thickness and a substantially circular through hole in the center through which a spool shaft with or without a sleeve is insertable, and has a plurality of through or bottomed holes with different depths at predetermined intervals in a circumferential direction, and the plurality of holes are opened so as to communicate with the through hole in the center of the stop position defining member. On the other hand, the spool shaft or the sleeve is provided with a positioning protrusion protruding substantially perpendicular to the axial direction of the spool shaft near the end of the urging member on the side opposite to the moving member, and the protrusion is fitted in any one of the plurality of holes of the stop position defining member. In a particularly preferred embodiment, among the plurality of holes, holes at positions facing each other across the center of the substantially circular through hole through which the spool shaft is insertable have substantially the same depth, the spool shaft or the sleeve, on the other hand, is provided with a pair of positioning protrusions protruding in opposite directions substantially perpendicular to the axial direction of the spool shaft near the end of the urging member on the side opposite to the moving member, and the pair of protrusions is fitted in any pair of the holes having substantially the same depth, among the plurality of holes of the stop position defining member.

In a reel of the present invention, the cam mechanism comprises a cam pin and a cam contact end with the shape described above. The cam contact end has a structure in which substantially half of a partition wall for forming a cam groove is removed, and the cam pin is in contact with only one partition wall and, in some cases, may be even temporarily in a non-contact state with the partition wall. The cam pin thus does not receive frictional resistance from the two partition walls. Therefore, the cam pin can move with a smaller force and quickly return to the initial position with a smaller force after casting of a lure, etc.

The cam contact end has a structure opened to the outside, so even if sand or other foreign matter enters inside, the foreign matter can be easily cleaned out by washing with water or the like, and the cam mechanism can be easily cleaned and lubricated.

In addition, a metal material constituting the periphery of a cam groove, which forms the groove, can be greatly reduced, making the moving member and thus the reel lighter.

In a preferred embodiment, because the cam contact end has a shape defined by a line that has an apex at a position corresponding to the axial center of the spool shaft, and that is line-symmetric with respect to the spool shaft, the cam contact end can exhibit a similar function regardless of the rotation direction of the spool. Thus, the adjustment mechanism can be constituted by the same components regardless of whether the reel is a right handle model or a left handle model.

Further, in a preferred embodiment, the distance between the magnetic and conductive members can be finely adjusted easily by the above-described stop position defining member and, optionally the positioning protrusion.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1(a) is a schematic view schematically illustrating a cam mechanism of a reel disclosed in Japanese reference JP-B-3464362, and FIG. 1(b) is a schematic view schematically illustrating a cam mechanism of a reel disclosed in Japanese reference JP-B-6376572.

FIG. 2 is a perspective view schematically illustrating an appearance of a bait reel according to one embodiment of the present invention.

FIG. 3 is a perspective view illustrating an appearance of a spool installed in the bait reel according to one embodiment of the present invention.

FIG. 4 is a partial cross-sectional view schematically illustrating an internal structure of the bait reel according to one embodiment of the present invention. Some structures are omitted for the sake of simplicity of the figure. Further, a brake adjustment mechanism 18 is expressed as a side view, and a conductive member 17 is illustrated in a cross-sectional view only in the vicinity of an outer extension.

FIG. 5 is a partial cross-sectional view illustrating an overview of an exemplified electromagnetic brake structure installed in the bait reel according to one embodiment of the present invention.

FIG. 6 is a partial cross-sectional view illustrating an overview of another exemplified electromagnetic brake structure installed in the bait reel according to one embodiment of the present invention.

FIG. 7 is a partial cross-sectional view illustrating an overview of still another exemplified electromagnetic brake structure installed in the bait reel according to one embodiment of the present invention.

FIG. 8 is a partial cross-sectional view illustrating an overview of still exemplified electromagnetic brake structure installed in the bait reel according to one embodiment of the present invention.

FIG. 9 is a perspective view illustrating a stop position defining member (washer) and an engagement member of a moving member used in the bait reel according to one embodiment of the present invention.

FIG. 10 is a side view illustrating that washers having different thicknesses are attached to a spool shaft in a bait reel according to one embodiment of the present invention.

FIG. 11A is a schematic view illustrating a state where, in a bait reel according to another embodiment of the present invention, a protrusion protruding in a direction substantially perpendicular to an axial direction of the spool shaft on a spool shaft or a sleeve is fitted in a doughnut-shaped stop position defining member having a plurality of holes with different depths in a circumferential direction on a surface on a side of the moving member.

FIG. 11B is a perspective view illustrating a state before the stop position defining member set forth in FIG. 11A is fitted to the spool shaft having the protrusion on the sleeve.

FIG. 11C is a cross-sectional view illustrating a plurality of through holes or bottomed holes having different depths of the stop position defining member illustrated in FIGS. 11A and 11B.

FIG. 12 is a conceptual view schematically illustrating a rotation control mechanism of the bait reel according to the one embodiment of the present invention.

FIG. 13 is a perspective view illustrating a braking force adjustment mechanism provided in the bait reel according to the one embodiment of the present invention. A spool shaft 2 including a sleeve 3 is inserted into a moving member 19 having a disk-shaped conductive member 17 attached to an end, and the moving member 19 is disposed so that a cam pin 22 provided in the sleeve 3 is engaged with a V-shaped notched end 21 of the moving member 19 at an initial position.

FIG. 14 is a perspective view illustrating the spool shaft including the sleeve with a cam pin provided in the bait reel according to the one embodiment of the present invention.

FIG. 15 is a perspective view illustrating a moving member provided in a bait reel according to one embodiment of the present invention wherein the disk-shaped conductive member is attached to and an urging member is fitted in.

FIG. 16 is a side view illustrating a braking force adjustment mechanism provided in a bait reel according to one embodiment of the present invention. A spool shaft 2 with a sleeve 3 is inserted into a moving member 19 having a disk-shaped conductive member 17 attached around the end, and the moving member 19 is disposed in such a manner that a cam pin 22 provided in the sleeve 3engages with a V-shaped notched end 21 of the moving member 19 at the initial position. Further, the urging member 23 is disposed adjacent to the end of the moving member 19 on the side opposite to the cam contact end 21 and is fixed by a washer 20 and an engaging member 26.

FIG. 17 is a schematic diagram illustrating operations of a rotation control mechanism of a bait reel according to one embodiment of the present invention in an early stage, a middle stage, and a late stage when a lure, etc. is casted with the bait reel.

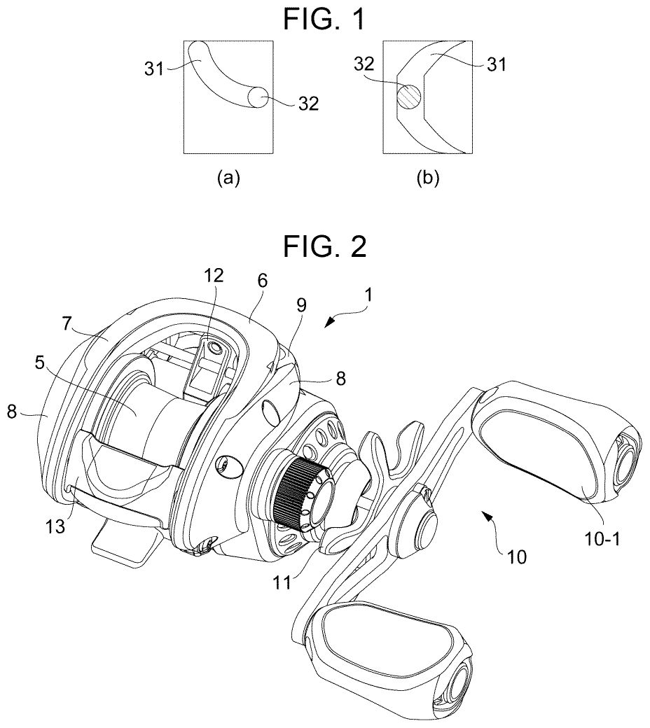

### DETAILED DESCRIPTION OF THE DRAWINGS

Embodiments of the present invention will be described in detail. However, the present invention should not be understood as being limited to the following embodiments.

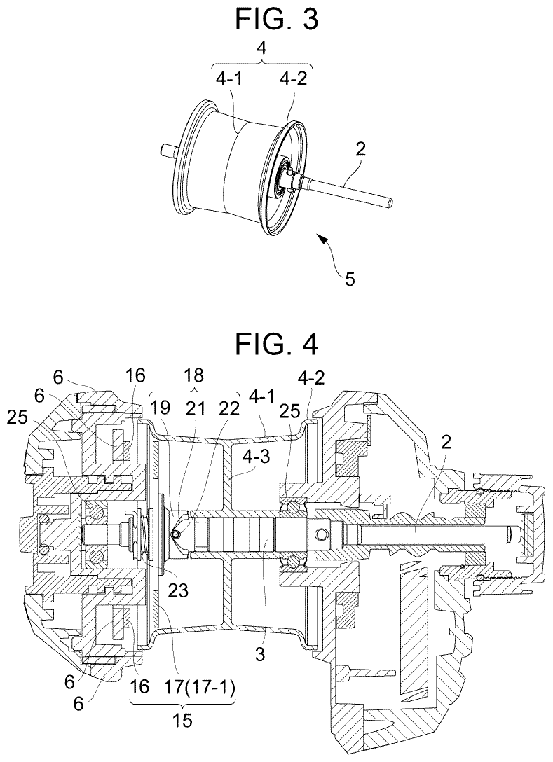

FIG. 2 is a perspective view illustrating an appearance of a fishing reel according to one embodiment of the present invention. FIG. 3 is a perspective view illustrating an appearance of a spool installed in a bait reel according to one embodiment of the present invention. FIG. 4 is a partial cross-sectional view schematically illustrating an internal structure of a bait reel according to one embodiment of the invention.

As illustrated in FIG. 2, the fishing reel of this embodiment is a double-bearing reel and is a low profile type reel for bait casting. In the bait casting reel 1, as illustrated in FIGS. 2 and 3, a spool 5 comprising a spool shaft 2 and a spool arbor 4 connected to the spool shaft 2 is rotatably held by a reel frame 6, and a handle assembly 10 that transmits rotational motion to the spool shaft 2 is disposed on a side of the reel. Further, a star drag 11 for adjusting a drag is provided on the reel frame side of the handle assembly 10.

The reel frame 6 comprises a frame main body 7, side covers 8 provided on both sides of the frame main body 7, and a front cover 9 provided in front of the frame main body 7.

As illustrated in FIGS. 2, 3, and 4, the spool 5 comprises a spool shaft 2 composed of a bar-shaped member, optionally a sleeve 3 fixed to the spool shaft to cover a part of the spool shaft 2, and a spool arbor 4. The spool arbor 4 comprises a cylindrical winding main body 4-1, a spool flange 4-2 extending outward on both sides of the winding main body, and a spool connecting member 4-3 that is a disk-shaped member extending from an inner surface of the spool arbor main body 4-1 at substantially medium portion in an axial direction of the spool shaft 2 on toward the spool shaft, and connects the spool arbor main body 4-1 and the spool shaft 2 so as to be coaxial.

In another embodiment, the sleeve 3 fixed to the spool shaft 2 so as to cover at least a part of the spool shaft 2 is provided, the spool connecting member 4-3 is connected to the sleeve 3, and the spool 5 is fixed so as to be coaxial with the spool shaft 2 via the sleeve 3.

The material forming each member constituting the spool 5 is not particularly limited, and the spool can be constituted by an appropriate material in consideration of characteristics such as strength, corrosion resistance, weather resistance, scratch resistance, and density. The spool shaft and the sleeve can be constituted by, for example, stainless steel or aluminum alloy, and the spool arbor can be constituted by, for example, titanium alloy or magnesium alloy.

As illustrated in FIG. 4, the spool 5 is rotatably held via a bearing 25 by the spool shaft 2 as a rotation shaft in a reel frame 6 and is preferably detachably held in the reel frame 6.

As illustrated in FIG. 2, the handle assembly 10 comprises a handle 10-1 that is disposed on a side of a reel frame 6 (side cover 8) and is rotatable around a rotation axis, and a transmission mechanism (not illustrated) that transmits rotational force of the handle to a spool shaft 2. In this reel, a level winder 12 for evenly winding a line is provided on a side where the line is ejected (upper side of FIG. 2), and, on the side opposite to the side where the line is ejected(lower side of FIG. 2), a clutch lever 13 connected to a clutch mechanism is provided to switch between a state where rotational force of the handle 10-1 can be transmitted to the spool shaft 2 and a state where the spool 5 is in a free rotation state and the line wound thereon can be released.

When casting a lure, etc., the clutch lever 13 is turned off, the fishing line is held down with the thumb or the like to prevent a spool 5 from rotating on its own, a casting posture is taken, the thumb or the like holding the fishing line is released at a timing when the lure, etc. is thrown to cast the lure, etc. to a desired location. The spool 5 is brought into a free rotation state, the fishing line is pulled by the lure, etc. and ejected from the spool arbor, and the spool 5 starts to rotate.

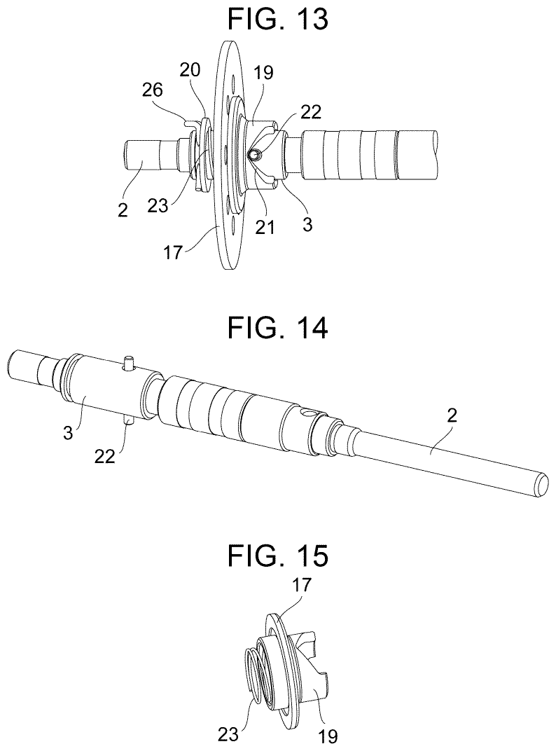

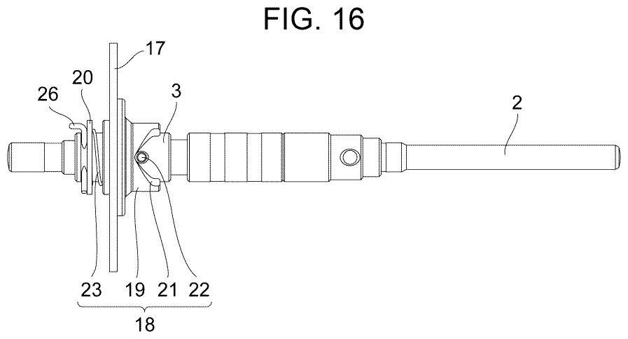

As illustrated in FIG. 4 to 17, bait casting reels according to embodiments of the invention comprises a rotation control mechanism 14 that can control the rotation of a spool to prevent backlash, in addition to the basic configuration described above.

A rotation control mechanism 14 of bait reels 1 of the embodiments comprises an electromagnetic brake structure 15 and a brake adjustment mechanism 18 that adjusts braking force.

The electromagnetic brake structure 15 is structured to generate braking force against the rotation of a spool by magnetic force, and, as illustrated in FIGS. 4 to 8 and 12, comprises a magnetic member 16 and a conductive member 17.

The magnetic member 16 is only required to have a function of generating magnetism to the conductive member 17 and can be composed of, for example, a permanent magnet.

The conductive member 17 is a conductive member that generates eddy currents on its surface by action of the magnetic member 16 when brought close to the magnetic member 16.

For example, it can be composed of a nonmagnetic conductor such as aluminum or an aluminum alloy. It can be also composed of a copper or aluminum foil on a base material molded with a synthetic resin such as acrylonitrile butadiene styrene (ABS resin), polyoxymethylene (POM) resin, polyphenylene sulfide (PPS) resin, or polyether ether ketone (PEEK) resin.

The distance between paired magnetic member 16 and conductive member 17 varies depending on a moving member 19 described below, but the distance between initial positions of them need to be set in such a manner that the moving member 16 and the conductive member 17 come close to each other so at to allow the magnetic member 16 to act on the conductive member 17 to generate eddy current. Such initial positions of the paired magnetic member 16 and conductive member 17 can be determined depending on a position where a stop position defining member for the moving member is installed, a structure, a size, and an installation position of the moving member, an installation position, a size, and a structure of the magnetic member 16 or the conductive member 17 connected to the moving member, a structure of a reel frame, and an installation position, a size, and a structure of a conductive member 17 or a magnetic member 16 connected to a reel frame, and the like.

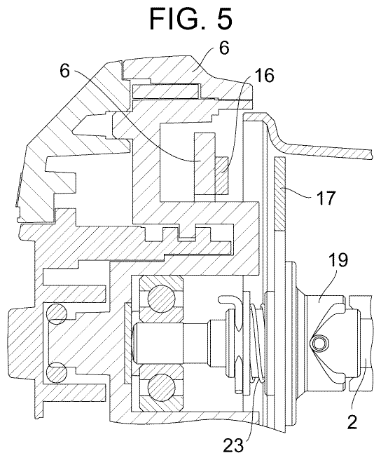

Because of the ease of adjusting the amount of eddy current by a brake adjustment mechanism, they are usually disposed to face each other in a spool axial direction. For example, as illustrated in FIGS. 4 and 5, one of a magnetic member 16 and a conductive member 17 is disposed in the brake adjustment mechanism 18, and the other is in the reel frame 6, at positions where eddy current can be generated on the surface of the conductive member 17 by action of the magnetic member 16 when the braking force adjustment mechanism 18 brings them close to each other, and they are typically disposed to face each other in the spool axial direction.

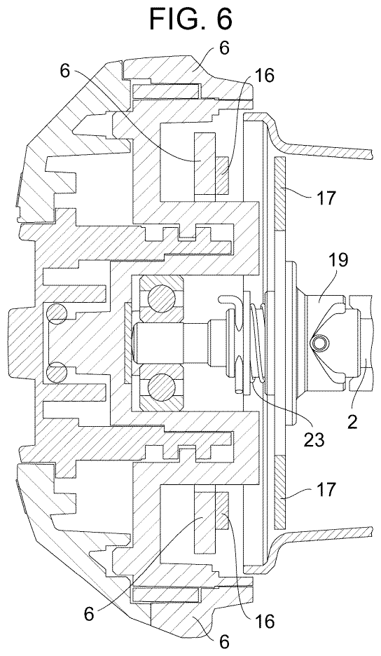

According to one embodiment, as illustrated in FIG. 6, the conductive member 17 may have a disk shape; a plurality of magnetic members 16 may be arranged at constant intervals, typically at equal intervals, in a circumferential direction of the spool shaft 2; and they face each other at a distance at which eddy current can be generated on the surface of the conductive member 17 by action of the magnetic bodies 16 when the braking force adjustment mechanism 18 brings them close to each other.

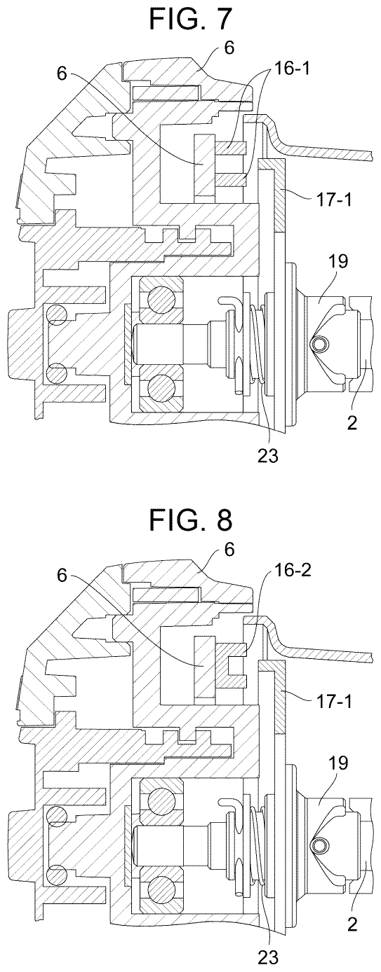

According to another embodiment, as illustrated in FIGS. 7 and 8, a conductive member 17-1 has a cylindrical shape coaxial with the spool shaft, while magnetic members 16-1 and 16-2 have a U-shaped cross section or are constituted by a pair of facing plate-shaped members. When the braking force adjustment mechanism 18 bring them close to each other, a cylindrical end of the conductive member 17-1 can be accommodated in a recess of the magnetic member 16-1 with a U-shaped cross section or a gap in the magnetic member 16-2 constituted by a pair of plate-shaped members facing at a certain interval. In this case, the eddy current generated by action of the magnetic bodies 16-1 and 16-2 on the conductive member 17-1 increases according to the entry amount of a distal end.

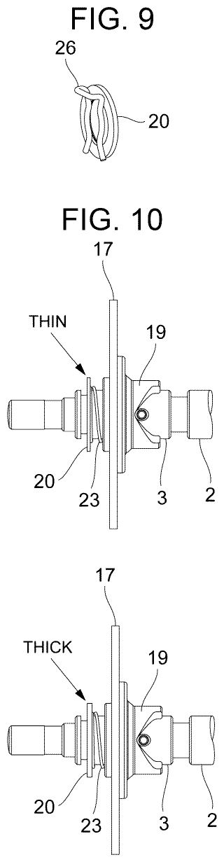

In addition, in a case where it is desired to finely adjust the distance between paired magnetic member 16 and conductive member 17, as illustrated in FIG. 10, the stop position of a moving member 19 may be finely adjusted by changing the thickness of a stop position defining member 20 or using multiple stop position defining members 20 stacked according to an expected distance between the magnetic member 16 and the conductive member 17. As the stop position defining member 20, for example, a washer 20 illustrated in FIG. 9 can be used, and as a fixing member for fixing the stop position defining member 20, an engagement member 26 such as a clip is preferable in that removal is simple and a structure of a braking force adjustment mechanism described below can be simplified.

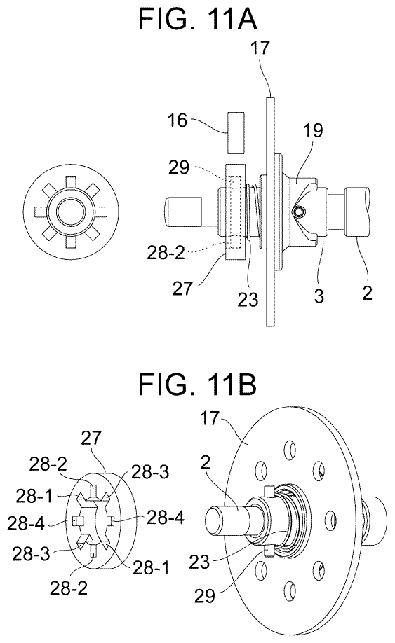

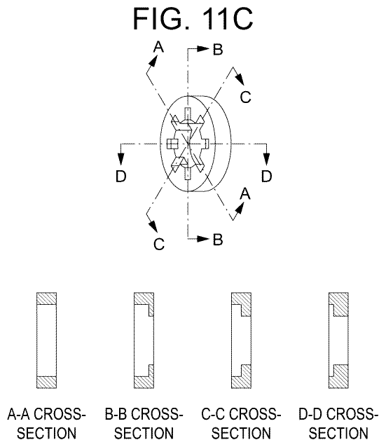

The distance between paired magnetic member 16 and conductive member 17 can also be finely adjusted by a stop position defining member 27 having a different structure illustrated in FIGS. 11A to 11C. The stop position defining member 27 is in a doughnut-shape with a predetermined thickness and a substantially circular through hole in the center through which a spool shaft 2 with or without a sleeve 3 is insertable and has a plurality of through or bottomed holes or grooves 28-1 to 28-4 with different depths at predetermined intervals in the circumferential direction. The plurality of holes or grooves 28-1 to 28-4 is opened to communicate with the through hole in the center of the stop position defining member 27. On the other hand, the spool shaft 2 or the sleeve 3 is provided with a positioning protrusion 29 that protrudes substantially perpendicular to the axial direction of the spool shaft 2 near the end of the urging member 23 on the side opposite to the moving member. The through hole 28-1 of the stop position defining member 27 is formed in a shape and a size through which the protrusion 29 can pass, and after the protrusion 29 is inserted into the through hole 28-1, the stop position defining member 27 is rotated to fit the protrusion 29 into any one of the other bottomed holes or the grooves 28-2 to 28-4. In the preferred embodiment, as illustrated in FIG. 11C, the holes (28-1, 28-2, 28-3, and 28-4) at the corresponding positions across the center of the central circular through hole have the same depth, and are deeper in order in the circumferential direction. On the other hand, the spool shaft 2 or the sleeve 3 is provided with two positioning protrusions 29 protruding in opposite directions substantially perpendicular to the axial direction of the spool shaft 2. The through holes 28-1 of the stop position defining member 27 are formed in a shape and size through which allow the protrusions 29 to pass, and the protrusion 29 are inserted into the through holes 28-1, and then the stop position defining member 27 is rotated to fit the protrusions 29 into other bottomed holes or grooves 28-2 to 28-4. The distance between paired magnetic member 16 and conductive member 17 can be adjusted by attaching the stop position defining members 27 to fit two protrusions 29 on the spool shaft 2 or the sleeve 3 into a pair of holes (28-1, 28-2, 28-3, or 28-4) with an appropriate depth according to an expected distance between the paired magnetic member 16 and conductive member 17.

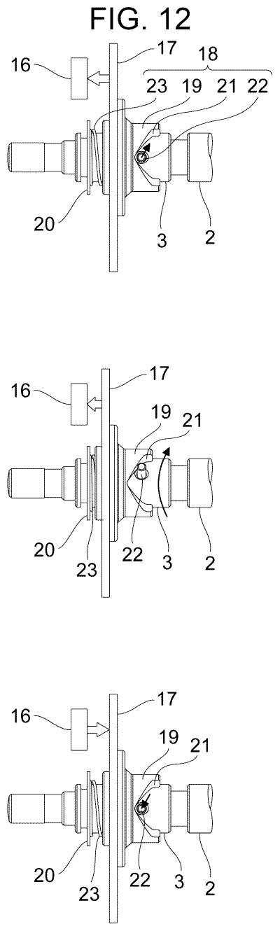

As illustrated in FIGS. 12 to 16, a braking force adjustment mechanism 18 comprises a cam pin 22 provided on a spool shaft 2 or a sleeve 3; a moving member 19 to which a magnetic member 16 or conductive member 17 is connected and which has a cam contact end 21 with which the cam pin 22 can engage; and a urging member 23 that presses the moving member in the spool axial direction from one end side.

As illustrated in FIGS. 12 to 14, A cam pin 22 is provided on a spool shaft 2 or a sleeve 3 and protrudes in a direction substantially perpendicular to the axial direction of the spool shaft 2, and it has a substantially columnar shape. The cam pin 22 can be formed, for example, by providing a bottomed or through hole with a predetermined diameter in the spool shaft 2 or the sleeve 3 and fitting a rod-shaped member with the same diameter and a predetermined height into the bottomed hole or the through hole. In this case, for example, a threaded groove can be formed in the inner wall of the bottomed hole or the through hole and a screw thread can be formed in a part of the cam pin 22, and then the cam pin 22 can be screwed and fixed to the bottomed hole or the through hole. In addition, a part of the cam pin 22 may be bonded to the inner wall surface of the bottomed hole or the through hole with an adhesive.

As illustrated in FIGS. 12, 13, 15, and 16, the moving member 19 is a cylindrical member with a circular cross section that is rotatable coaxially with a spool shaft 2 and is movable in the axial direction of the spool shaft 2 within a certain range. A spool shaft 2 or a spool shaft 2 having a sleeve 3 is inserted into the hollow space of the moving member 19, and the moving member 19 is disposed such a manner as to allow the cam pin 22 provided on the spool shaft 2 or the sleeve 3 to engage with the cam contact end 21 of the moving member 19.

A magnetic member 16 or conductive member 17 is connected to the moving member 19 at or near the end opposite to the cam contact end 21 in the axial direction of the spool shaft 2. Therefore, the moving member 19 is designed and disposed such a manner as to allow a magnetic member 16 or a conductive member 17 connected at or near one end thereof to be positioned at a predetermined distance with respect to a conductive member 17 or a magnetic member 16 disposed at a predetermined position in a reel frame 6, while allowing the cam pin 22 to engage with the other end 21 to enable predetermined movements.

The cam contact end 21 may be designed to have a shape defined by a line inclined with respect to the axial center of the spool shaft 2, and the degree of the inclination angle can be determined and changed in consideration of an assumed rotational difference between the moving member 19 and the spool shaft 2. If the inclination angle of the spool shaft with respect to the axial center is made acute, the moving speed of the moving member 19 with respect to a rotational difference between the moving member 19 and the spool shaft 2 (in other words, a difference from the rotation speed of a spool) can be increased. In contrast, if the inclination angle is made obtuse, the moving speed of the moving member 19 with respect to the rotational difference between the moving member 19 and the spool shaft 2 can be decreased. Therefore, the shape of the cam contact end 21 can be determined from this point of view.

A cam contact end 21 preferably has a shape defined by a line that is line-symmetric with respect to the spool shaft in terms of being able to utilize the same members regardless of whether the handle assembly is installed on the left or right. According to a preferred embodiment, such a cam contact end 21 has a shape defined by a line having a apex at a position corresponding to the axial center of the spool shaft 2, sloping away from the apex in the vertical directions with respect to the axial center of the spool shaft toward the side opposite to the magnetic or conductive member, and with line-symmetry with respect to the spool shaft.

For example, included are a V shape rotated clockwise by 90 degrees and positioned to be line-symmetric with respect to the spool shaft, a U shape rotated clockwise by 90 degrees, and positioned to be line-symmetric with respect to the spool shaft, and a shape defined by two line-symmetric arc-shaped lines connected to form an apex at a position corresponding to the axial center of the spool shaft.

In a reel of the present invention, a moving member 19 does not have a cam groove but has a structure in which roughly half of the partition wall for forming the cam groove is removed. As a result, the cam pin is regulated by only one partition wall, and in some cases, the cam pin may be even temporarily in a non-contact state with the partition wall. The cam pin thus does not receive contact resistance from two partition walls. In addition, a base material around the cam groove for forming the cam groove is substantially halved to form a cam contact end, which allows the weight of a moving member to be reduced.

As illustrated in FIGS. 10, 11, 12, and 16, an urging member 23 is a member that presses a moving member 19 from the side where a magnetic member 16 or a conductive member 17 is connected to the moving member 19 toward the handle assembly side (the side opposite to the end at which the magnetic member 16 or the conductive member 17 is connected) in the spool axial direction. An urging member 23 is only required to have such a function, and can be composed of, for example, an elastic member such as a known spring or rubber. When being composed of a spring, urging force can be easily adjusted by selecting an appropriate material and adjusting thickness of the spring.

An urging member 23 may be disposed in such a manner as to exhibit the above-described function, but is usually disposed adjacent to the end of a moving member directly or via another member and is positioned by a stop position defining member 20 attached to a spool shaft 2 or a sleeve 3 on the side opposite to the side of the moving member, so that the urging state is maintained.

In a bait reel comprising a rotation control mechanism 14, which comprises an electromagnetic brake structure 15 and a brake adjustment mechanism 18 described above, the rotation speed of a spool is controlled by a rotation control mechanism according to a difference between the amount of a fishing line supplied from a spool arbor of the spool and the amount of a fishing line pulled by a lure, etc. when the difference between the both amounts occurs, and the spool can be prevented from being excessively rotated.

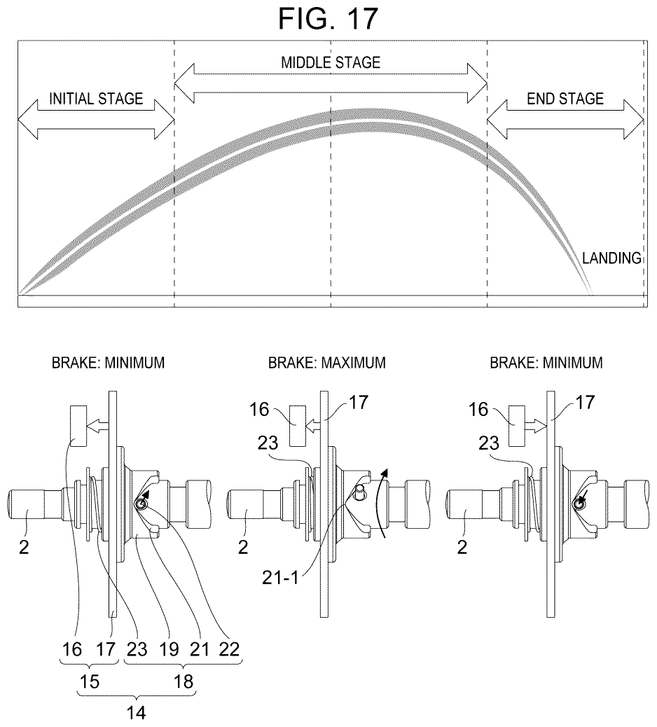

Specifically, as schematically illustrated in FIG. 17, at the initial stage of casting, the rotation speed of a spool (not illustrated) is low, and thus rotational force generated by the rotation of the spool (not illustrated) is smaller than urging force by an urging member 23. In this state, a moving member 19 rotates integrally with a spool shaft 2, and there is no difference in rotational speed between the moving member 19 and the spool shaft 2, so that a cam pin 22 remains at an apex 21-1 of a cam contact end 21. As a result, the moving member 19 remains in the initial position, a magnetic member 16 or a conductive member 17 connected thereto is located farthest from the other conductive member 17 or magnetic member 16 of the pair, and the braking force against the rotation of the spool (not illustrated) is the smallest.

On the other hand, as the rotation of the spool (not illustrated) becomes faster following the flight speed of a lure, etc., the rotational force of the spool exceeds the urging force by the urging member 23. In this state, a rotational difference is generated between the rotation of the moving member 19 and the rotation of the spool shaft 2, and the cam pin 22 moves along the cam contact end 21 in contact with the cam contact end 21 from the apex 21-1, and moves the moving member 19 toward the side opposite to the cam contact end 21 (the left side of FIG. 17) in the axial direction of the spool shaft 2. As a result, the magnetic member 16 or the conductive member 17 connected to the moving member 19 moves toward the other conductive member 17 or magnetic member 16 held in a reel frame (not illustrated). Moving speed of the conductive member 17 or the magnetic member 16 depends on rotational force of the spool (not illustrated), and the conductive member 17 or the magnetic member 16 can move up to a stop position defined by a stop position defining member 20 at the maximum. Braking force against the rotation of the moving member 19 is generated according to the distance between paired conductive member 17 and magnetic member 16, and braking force against the rotation of the spool (not illustrated) is then generated via the cam mechanism. As a result, excessive rotation of the spool (not illustrated) is reduced, and backlash is prevented.

Note that, in this reel, the moving member 19 is notched in a V shape to reduce weight, and the cam pin 22 does not receive contact resistance from two partition walls. Thus, the cam pin 22 can be moved with a smaller force.

At the stage where the lure, etc. lands on the water after passing the apex, the rotation speed of the spool (not illustrated) is reduced by the rotation control mechanism, and the force with which the cam pin 22 presses the cam contact portion 21 becomes smaller. Then, when the urging force of the urging member (not illustrated) exceeds the rotational force of the spool, the cam pin 22 moves toward the apex 21-1 of the cam contact end 21 along the cam contact end 21 or temporarily without contacting the cam contact end 21, and finally returns to the apex 21-1 of the cam contact end 21. Thus, the moving member 19 moves to the handle side (the side opposite to the end to which the magnetic or conductive member is connected) (the right side of FIG. 17) in the axial direction of the spool shaft 2, and finally returns to the initial position. As a result, the magnetic member 16 or the conductive member 17 connected to the moving member 19 moves away from the other conductive member 17 or magnetic member 16 held in the reel frame (not illustrated), and the electromagnetic force that the conductive member 17 receives from the magnetic field of the magnetic member 16 decreases. Therefore, the braking force against rotation of the spool is also reduced, and is minimized when the spool finally returns to the initial position.

Note that, in this reel, the moving member 19 is notched in a V shape to reduce weight, and the cam pin 22 does not receive contact resistance from two partition walls, so that the cam pin 22 and the moving member 19 can move with a smaller force even in the return operation.

In this reel, through such an operation, it is possible to effectively prevent backlash by applying an appropriate braking force to the spool without unnecessarily decreasing the flying distance.

### REFERENCE SIGNS LIST

1 Bait reel
2 Spool shaft
3 Sleeve
4 Spool arbor
4-1 Spool arbor main body
4-2 Spool flange
4-3 Spool connecting member
5 Spool
6 Reel frame
7 Frame main body
8 Side cover
9 Front cover
10 Handle assembly
10-1 Handle
10-2 Transmission mechanism
11 Star drag
12 Level winder
13 Clutch lever
14 Rotation control mechanism
15 Electromagnetic brake structure
16 Magnetic member
16-1 Magnetic member constituted by a pair of two plate-shaped members
16-2 Magnetic member having U-shaped cross section
17 Conductive member
17-1 Cylindrical conductive member
18 Brake adjustment mechanism
19 Moving member
20 Stop position defining member (washer)
21 Cam pin contact end
21-1 Apex
22 Cam pin
23 Urging member
25 Bearing
26 Locking member (clip)
27 Stop position defining member
28(28-1 to 28-4) Hole
29 Positioning protrusion
31 Cam groove (conventional art)
32 Cam pin (conventional art)

1. A bait reel comprising:
a spool comprising a spool shaft and a spool arbor connected to the spool shaft or the sleeve,
a reel frame that rotatably holds the spool, and
a rotation control mechanism capable of controlling rotation of the spool, wherein the rotation control mechanism comprises an electromagnetic brake structure that generates braking force against rotation of the spool, and a braking force adjustment mechanism that controls the braking force;
wherein the electromagnetic brake structure comprises paired magnetic and conductive members, and one of the magnetic and conductive members is disposed to the braking force adjustment mechanism and the other to the reel frame in such a manner they are capable of becoming close to each other by the braking force adjustment mechanism;
wherein the braking force adjustment mechanism comprises:
a cam pin that is provided on the spool shaft or the sleeve and protrudes in a direction substantially perpendicular to an axial direction of the spool shaft,
a moving member in a cylindrical form with a circular cross section that is rotatable coaxially with the spool shaft and is movable in the axial direction of the spool shaft within a certain range, wherein the moving member has a cam contact end with which the cam pin is engageable, and
an urging member that presses the moving member in a spool axial direction from one end side;
wherein the magnetic or conductive member is connected to or near an end of the moving member on the side opposite to the cam contact end, and the cam contact end has a shape defined by a line inclined with respect to an axial center of the spool shaft,
wherein the urging member presses the moving member from the side of the magnetic or conductive member to allow the cam pin to engage with the cam contact end, and the moving member to which the magnetic or conductive member is fixed, to move in the axial direction of the spool shaft according to a difference between rotational speed of the spool and rotational speed of the moving member, thereby controlling a distance between the paired magnetic member and conductive member.

2. The bait reel according to claim 1, wherein the cam contact end has a shape defined by a line having an apex at a position corresponding to an axial center of the spool shaft, and sloping away from the apex in vertical directions with respect to the axial center of the spool shaft toward the side opposite to the magnetic or conductive member, and with line-symmetry with respect to the spool shaft.

3. The bait reel according to claim 1, further comprising a stop position defining member fixed to the spool shaft or the sleeve in such a manner as to disposed adjacent to the urging member directly or via another member on the side opposite to the moving member side of the urging member, thereby positioning the urging member and maintaining urging force.

4. The bait reel according to claim 3, wherein
the stop position defining member is in a doughnut-shape with a substantially circular through hole in the center through which the spool shaft with or without the sleeve is insertable, and has a plurality of through or bottomed holes with different depths at predetermined intervals in a circumferential direction on the surface at the moving member side,
the plurality of holes are opened so as to communicate with the through hole in the center of the stop position defining member,
the spool shaft or the sleeve, on the other hand, is provided with a positioning protrusion protruding substantially perpendicular to the axial direction of the spool shaft near the end of the urging member on the side opposite to the moving member, and the protrusion is fitted in any one of the plurality of holes of the stop position defining member.

5. The bait reel according to claim 4, wherein
among the plurality of holes, holes at positions facing each other across the center of the substantially circular through hole through which the spool shaft is insertable have substantially the same depth,
the spool shaft or the sleeve, on the other hand, is provided with a pair of positioning protrusions protruding in opposite directions substantially perpendicular to the axial direction of the spool shaft near the end of the urging member on the side opposite to the moving member, and the protrusions are fitted in any pair of the holes having substantially the same depth, among the plurality of holes of the stop position defining member.
